(19) United States
(12) Patent Application Publication
(10) Pub. No.: US 2005/0175083 A1
(43) Pub. Date: Aug. 11, 2005

(54) Stereoscopic video capturing device and dual receiver with viewer for three-dimension display, and method thereof

(76) Inventor: Manuel Rafael Gutierrez Novelo, Guadalajara (MX)

Correspondence Address: Ralph A. Dowell of DOWELL & DOWELL P.C., 2111 Eisenhower Ave., Suite 406, Alexandria, VA, 22314, US

(21) Appl. No.: 10/375,365

(22) Filed: Feb. 28, 2003

Related U.S. Application Data
(63) Continuation-in-part of application No. PCT/MX01/00016, filed on Mar. 13, 2001.

(30) Foreign Application Priority Data
Sep. 1, 2000 (MX) 008564

(51) Int. Cl. H04N 7/12; H04N 13/00

(52) U.S. Cl. 375/240.01; 348/42

(57) ABSTRACT

This invention refers to a method and a device for capturing, transmitting, and displaying three-dimension video images of a scene; said device comprises a stereoscopic video camera that captures, encodes, amplifies, and modulates the captured image signal; a dual receiver-decoder that simultaneously processes the two independent signals carried by two different channels; a viewer with two liquid crystal displays on which the scene images carried by the independent channels are displayed; the left channel being displayed on the left display, and the right channel being displayed on the right display. For transmitting and receiving the two-dimension signals, this method and this device may use analog or digital technology, and the existing infrastructure as well. The principle consists in taking two images, left and right, which are treated individually, with no mixing between them, and which are sent by two independent TV channels having their own receiver and viewing display. One of the images may be sent to a conventional TV monitor, not loosing at all any of the signal attributes.

This is a Continuation-In-Part of PCT Application No. PCT/MX01/00016 filed on Mar. 13, 2001).

### FIELD OF THE INVENTION

This invention refers to a method, and a device for transmitting and receiving independent stereoscopic video images by using two conventional television channels, so that upon deploying the information, a three-dimension image is obtained. More particularly, this invention refers to a stereoscopic transmission and reception system for television signals able to produce a pair of signal beams that are perceived separately by each eye of an observer, without the need of polarization or any other manipulation of the signal, be it time and frequency separation, or color separation, or frame superposition.

### BACKGROUND OF THE INVENTION

French Patent No. 2,519,501 issued to Butterfield et al. on Jul. 8, 1983 relies on mixing two video images, left and right, which are first polarized or encoded with two different colors, each one being separated at the viewing time by means of passive color filters, much like the video signals that need polarizing lenses. At the viewing time, the observer needs to view through a single external device bearing certain kind of lenses that are the counterpart of the mixed color filters, a red filter and a cyan filter. This technology produces poor three-dimension vision. The system is a stereoscopic system based on a filtered color and on the superposition of images in different colors, one image for each channel (left-right). Other pairs of filters may be used, such as, red-blue, red-green, blue-green; the red-cyan combination is the best to have a better definition of a two-color vision of the stereoscopic image. A three-color vision can also be obtained by the use of a semi-silvered mirror and a blue filter in front of the object.

European Patent Application EP 0306,448 issued to Chevion et al. on Mar. 8, 1989, describes a method and a device to transmit and receive video images in the three dimensions, by using conventional video transmitting channels. The method consists in presenting two images of a scene with a slightly different view angles, then the images are sampled to generate for each image a set of image components following a preset pattern, so that first and second subsets of images are generated for each image. These sets are sent to a receiver, and a flat image is generated; then another subset of images is sent, and it applies a corrective factor to the first sent subset. Both image subsets are polarized to an orthogonal polarization, the observer must be provided with polarized lenses so that the left eye will only see the elements of the first subset, and the right eye will only see the elements of the second subset. The observer's eyes will see a slight difference in the image, much like a perspective view at low resolution of the original scene in a three-dimension fashion.

U.S. Pat. No. 5,870,137 issued to Herbert on Feb. 9, 1999, mainly describes and protects the alternating allocation of left and right frames to the observer's eye, by means of alternating filter devices, similar to shutters or splitting devices, which become black or clear, and need to be watched from an external device. This patent refers to a method for displaying a stereoscopic image, each image is built from a right-left frame, the display of the images is always allotted by the splitting devices, which always allot an image frame to each channel of the observer's eyes; each frame is progressively alternated with the other frame, and by means of lines the preset tracking pattern of the deployed image is scanned. Then, the video images are comprised of left and right alternating frame sequences in the same display, and a viewer device is used, which synchronically alternates the left and right frames at the time the observer watches a certain left or right frame. The use of the technology as described in Patent '137 produces poor results regarding the display of three-dimension images, and caused side effects, such as headaches.

As of today, a television program is created by focusing the (mono-scopic) television camera at a scene, transforming the received light into electronic video signals, which are combined with audio signals, and are then transmitted by means of electromagnetic waves carrying signals. Television cameras are provided with 3 basic components: an optic system for capturing the images, a collecting device which translates the images into video electromagnetic signals, and an encoder enabling transmission of the signal. In brief, the whole process consists in capturing-encoding-transmitting-receiving-decoding, and displaying flat images. The image delivered by this system is a flat image consisting only of two planes, due to its mono-scopic origin, that is, it is originated from a single lens in the camera which scans, both in a vertical and horizontal way, an area by using sensors, thereby covering a single perspective area equivalent to watching with just one eye, experiencing in this way a loss of dimensional characteristics, such as depth, volume or distance between two objects in the same plane.

In view of the foregoing there is a need of a stereoscopic television system based on the use of separated images for the whole stereoscopic viewing process, and not based on alternating or superimposing video beams. Each eye sees its own display and the image goes directly to that eye.

### BRIEF DESCRIPTION OF THE INVENTION

An object of this invention is to provide a stereoscopic television (three-dimension) system and method using either analog or digital technology, and which is not based on mixing frequency, time, or both in the captured or transmitted signal.

An additional object of this invention is to provide a stereoscopic television system wherein each eye has a view field which is complete in color, frequency, texture, etc.

Another object of this invention is to provide a stereoscopic television system for home or public services, which uses the existing technological infrastructure.

A further object of the invention is to provide a filming camera, a stereoscopic video camera which uses as the image capturing and transmitting means a stereoscopic camera having to parallel lenses, and the images are taken from two slightly different angles, which positions correspond to the left and right eyes of a human face.

Another additional object of the invention is to provide a stereoscopic television system comprising a stereoscopic video signal encoder using two output channels, one for the right image and the other for the left image.

Another additional object of the invention is to provide a stereoscopic television system comprising a stereoscopic video signal encoder using two input channels, one for the right image and the other for the left image.

Another object of the invention is to provide a color television device to project the complete television images sent by each independent path or commercial television channel (left-right).

Another object of this invention is to provide a stereoscopic television system using two independent television channels to carry the complete image signal of the same object.

It is another additional object of this invention to use the described novel results to apply them to commercial television, video games, PC, DVD, video conference transmission, etc.

Another object of this invention is to provide a three-dimension television system that does not produce side-effects in the observer.

Still another object of the invention is to provide a method to obtain, transmit, and receive stereoscopic television images in real time, with no polarization, with no superposition, and not using any kind of multiplexing devices.

It is an object of the invention to provide a set of devises allowing to emulate the stereoscopic vision of a human being.

Another additional object of the invention is to provide a method to create a three-dimension television system, consisting in taking the images, processing, encoding, transmitting, receiving, decoding, and displaying the same in a three-dimension view, without the need of an external monitor.

### BRIEF DESCRIPTION OF THE DRAWINGS

FIG. 1 represents a block diagram of the steps of the method to obtain the stereoscopic television system.

FIG. 2 shows a side and perspective view of a mono-scopic television camera.

FIG. 3 shows a side and perspective view of a stereoscopic television camera.

FIG. 4 shows three perspective views of a volume vision: mono-scopic left and right views, and stereoscopic left and right perspectives.

FIG. 5 shows an exploded view of the components of a stereoscopic television camera.

FIG. 6 shows the stereoscopic camera of FIG. 5 having the video signal output and transmission device for the two independent channels. Flow diagram of the encoding, amplifying, transmitting process in two independent and different television channels.

FIG. 7 shows the components of the receiver device (antenna and encoder) of the dual receiver device, and the stereoscopic image displaying device.

FIG. 8 shows an exploded view of the viewer or stereoscopic image displaying device.

FIG. 9 shows an exploded view of the stereoscopic image signal receiver device, that is, the stereoscopic decoder-receiver.

### DETAILED DESCRIPTION OF THE INVENTION

The three-dimension television signal transmitting device is comprised of three basic components: the stereoscopic camera (FIG. 3), the signal receiver-decoder (FIG. 7), and the stereoscopic viewer (FIG. 8), and requires a standard television signal broadcasting system.

The stereoscopic signal (2) takes the two image signals, and then encodes, modulates, and amplifies the same. The signals reach the receiver-encoder (7), which receives both of them by an independent channel each one, it receives audio and image signals, decodes each signal and sends them to the receiver (6), which displays the image in a stereoscopic fashion.

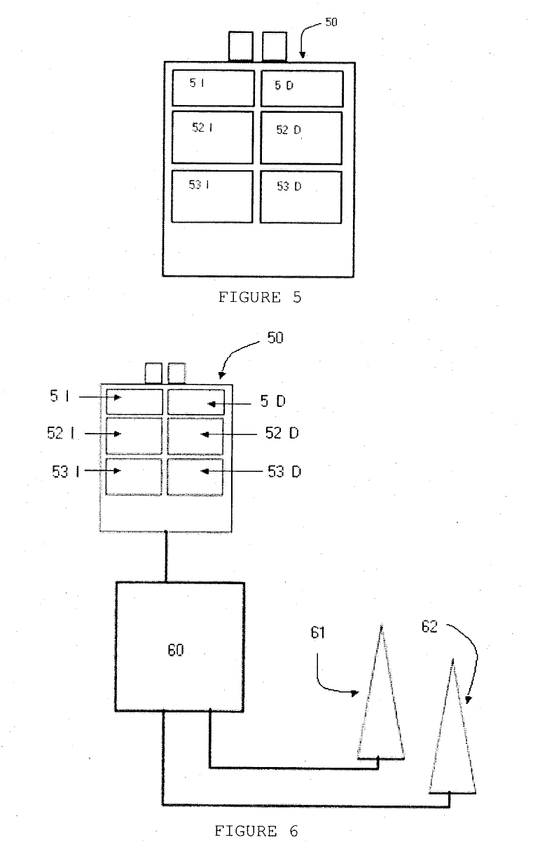

The image taken using the stereoscopic camera (2) of this invention is carried out simultaneously by two parallel lenses, and two collectors connected to them; the lenses being separated to each other by a distance equivalent to the average distance between the two centers of the pupils of the human eye, in this way it is certain that two images of the same object are taken at the same time (FIG. 5).

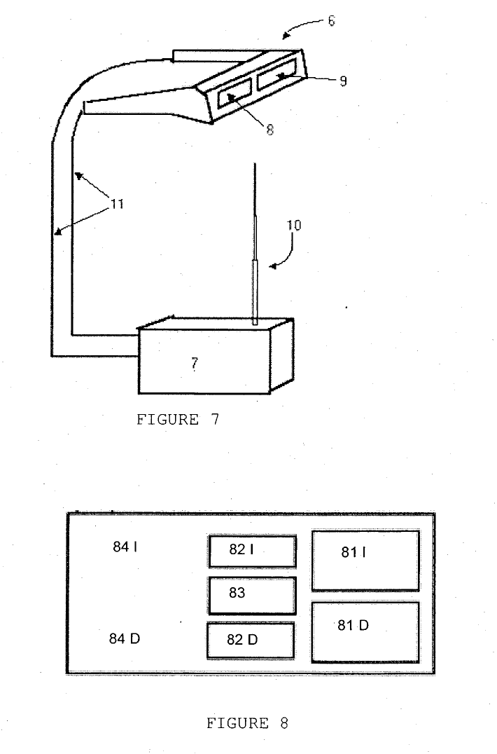

These images are collected, processed, and encoded in real time, independently for each left and right channels, using known methods and by any media: analog air, cable, satellite, or digital air (hdtv—high definition television). These media use the adequate software to perform the necessary operations to send the signal carrying the image; the software processes the signal, which might be recorded in coordinated recording systems, be them analog or digital, magnetic media, digital optic media, magnetic optic media, or hard disc. A real time broadcast is also possible by typical broadcasting means in any available channel or media FIG. 6), by using the existing infrastructure. The process of encoding, amplifying, transmitting, and modulating the signal is carried out in the stereoscopic camera. The signal is transmitted individually and simultaneously for two different transmission frequencies, such as the conventional broadcasting channels like channel 5 and channel 7, channel 11 and channel 13, or any other combination of any two independent channels. The same is applicable in satellite TV, cable or other media. For the particular case of HDTV, due to its features, two or more digitized video channels are included in the same analog frequency, sending a signal per channel (FIG. 6).

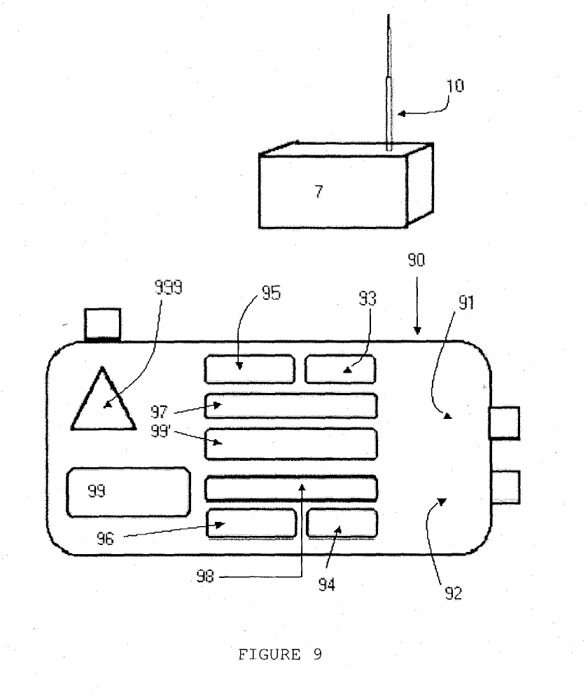

The dual decoder (7) has two built-in tuners with an appropriate software to direct each individual channel (left-right) to each display of the viewer. Each one receives the signal from a broadcasting channel by means of antenna (10), for example, channel 5 and channel 7, and are decoded individually (FIG. 9) to be sent each one to a display on the viewer. In this way, independent signals, left and right (11) are handled as in FIG. 7.

The viewer (6) consists either of a liquid crystal (8) and (9) or an active pixel visual display having enlarging features, both visual displays are set on the viewer, one for each display channel, left and right, in such a way that when the viewer is set, the image is presented to each eye by means of an individual liquid crystal or active pixel visual display, and the human brain works itself to transform both transmitted complete images into an stereoscopic three-dimension view, in real time.

Simultaneously, there is an audio system which decodes the surrounding stereo-signal which is already in use in television sets and home equipment (FIG. 9).

Power supply to the viewer circuitry and to the decoder is made either by long lasting lithium-ion batteries, or by a battery eliminator or a power supply that transform alternate current to continuos current (FIGS. 8 and 9).

When coordinating the simultaneous transmission to obtain stereoscopic video display, the human brain makes an image superimposing operation on the left and right images (3 and 4), just as if the observer were directly watching the displayed images with his/her own eyes. This effect appears when our brain decodes a signal coming from two independent sources (each source is a human eye), allowing to obtain a perspective view angle differential which lets us perceive the depth (volume) or the distance at which the objects being visualized are located. This stereoscopic vision (5) is the result of the superposition or combination of the images being individually received in the brain by each eye.

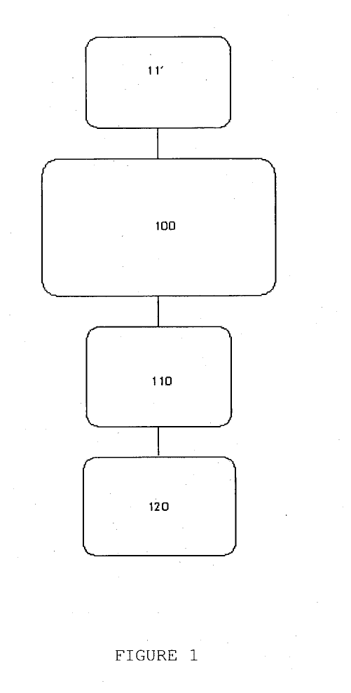

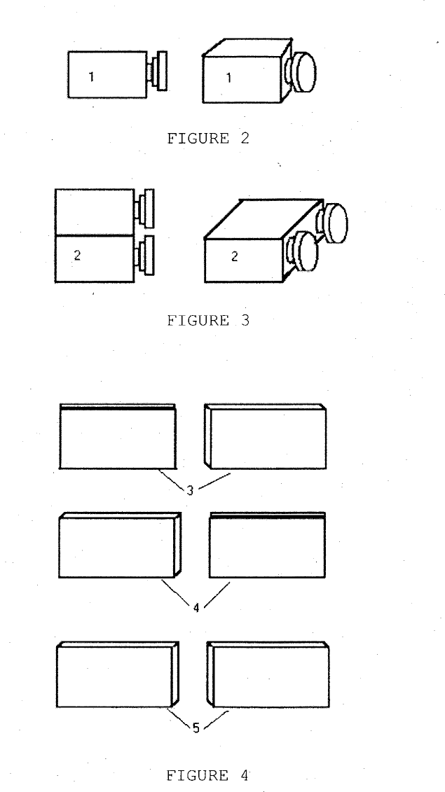

Returning to FIG. 1, numeral 11′ represents the stereoscopic TV camera used in this invention, with two signal outputs. Numeral 100 represents the broadcasting station that transmits the two signals via two separate channels. For example, channel 5 and channel 7, a right signal and a left signal each one. Then, numeral 110 represents the stereoscopic decoder with a built-in dual receiver, and numeral 120 represents the stereoscopic viewer with built-in displays, one per eye.

In connection with FIG. 5, it shows an exploded view of the stereoscopic camera 50 comprised of a left lens (5 L), and a right lens (5 R), a left collector (52 L) and a right collector (52 R), a left decoder (53 L) and a right decoder (53 R).

FIG. 6 shows the stereoscopic camera 50, the amplifier-modulator 60 for the two signals, left and right, the transmission antennae 61 and 62 for both signals.

FIG. 8 shows an exploded view of the components of viewer 80, such as the left liquid crystal display (81 L) fed by the left video channel, and the corresponding right display (81 R), the scanning circuits, left and right (82 L) (82R), and the power supply (83).

FIG. 9 shows an exploded view of the dual decoder (90) with the video and audio signal outputs, left and right, (91) and (92); the corresponding left and right decoders (93) and (94); and respectively the left and right receivers (95) and (96), the audio receivers (97) and (98); the power supply (99′), the battery (99) and the receiving antenna (999).

Any one skilled in the art will understand that the foregoing description only illustrates the invention and is not limitative thereof, being evident that there may be other advantages and applications than those already described herein, such as remotely driven surgery (due to the perspective and depth perception), remotely drive a car, remotely watching a football game with reality features in the field, broadcasting a live show with three-dimension features, recording advertising material allowing the consumer to perceive the precise features of the product in a three-dimension environment, like texture, thickness, etc., witnessing a trip; holding video conferences and perceiving all the volume and space details.

On the other hand, it is clear that the invention describes a method to simultaneously transmit stereoscopic video signals via two independent channels, in real time. The method consists of three main blocks: taking the images with the stereoscopic camera; receiving and decoding the dual signal; and displaying the images in the displays of the stereoscopic viewer.

The video stereoscopic camera carries out the steps of taking the images; processing, codifying, and transmitting the same via independent conventional TV channels.

The dual receiver and encoder carries out the step of receiving the independent image signals transmitted via the conventional TV channels, be them independent analog, cable, satellite, or hdtv channels, and the step or decoding the signal to be displayed on the viewer displays.

The complete image is displayed in the viewer, on the left and right displays. The image is obtained with no polarization, no delay, no change in frequency, no specific tracking pattern, no multiplexing, not deceiving the eye of the observer with a sequence of image frames.

The elements associated with the scene image are the same for each lens in the camera, and the only difference is the view angle.

The transmission method of this invention will produce an image by means of a receiver; the image being formed by two original attributes derived from the stereoscopic camera. A stereoscopic image will correspond to the simultaneous display of the two non-modified TV images that are transmitted by the camera. Both images are identical to the original scene and shall be watched respectively by the left eye and the right eye of the observer. The observer's brain will handle the two images as a single three-dimension image.

This invention allow us to use the conventional communication channels to transmit and receive signals within the television field. Furthermore, this method of transmitting and receiving data is compatible with the existing transmission and reception equipment used for two-dimension display. So this invention becomes a compatible system with the two-dimension television, not excluding or disabling it as it happens with other existing systems.

The receiver shall be adapted with a circuitry and corresponding software to process the transmitted data, so that the information of one channel is displayed only in the right or the left displays of the viewer, in the absence of an external monitor, and obviating it. In the same way, the transmitter shall be adapted to transmit such information corresponding to the same image to another different channel.

The processor at the transmission site comprises two receivers in parallel with its respective encoder and associated software, to modulate and amplify the output image. The amount of output data is coincident with the complete information captured by the camera, therefore it is not necessary to use an associated algorithm to rebuild the image.

Any conventional stereoscopic receiver which receives the captured and transmitted data by the method of this invention will not require re-processing the image data, and the data will be used directly, with no mixing, so as to display a two-dimension image either in the one display or in each display, as the case may be.

As seen in FIG. 9, the receiver comprises parallel means to receive and decode the non-mixed signal; the receiver receives the image-associated elements to send them to the image viewing displays.

The viewer is a device with two liquid crystal displays, in full color, with enlarging lenses. Each displays provides an image to the eye, the displays do not filter light, and do not require an external viewing monitor.

In the method of the invention it is not necessary to make a data correlation in order to found and filter an error signal, so a minimum amount of data to allow reconstruction of the original signal without loosing information is not needed at all.

The above specification refers to a method of transmitting and receiving TV images, particularly a method to process and transmit the captured image so that a three-dimension display is obtained. It shall be understood that once the image data have been captured, processed, and displayed, they may be stored into a magnetic media, such as, for example, video tape, optic disc, optic digital media, optic magnetic media, or digital hard disc, or the like.

1. A method for transmitting and receiving three-dimension video images of a scene, the method using conventional transmission channels, wherein the method comprises the step of:
(a) producing two independent video images taken from different view angles;
(b) encoding, modulating, and amplifying the data corresponding to the complete video images;
(c) transmitting the corresponding data from both video signals, with no mixing of the same, by independent and different video channels, left and right;
(d) receiving and decoding the transmitted video data; and
(e) independently and simultaneously displaying video images on the left and right displays of the viewer.
(f) recording the produced video images in a magnetic media, optic digital media, magnetic optic media, digital hard disc.

2. A method for transmitting and receiving three-dimension video images as per claim 1, further characterized in that all the elements and attributes that are associated with the image are kept unaltered, and are so sent to the receiver by conventional independent transmission channels for video signals.

3. A method for transmitting and receiving three-dimension video images as per claim 1, further characterized in that the difference in the view angle corresponds to the average distance between the pupils of the human eyes.

4. A method for transmitting and receiving three-dimension video images as per claim 1, further characterized in that displaying the images in three dimensions is carried out by independent projections of each channel on the left and right displays of the viewer, not requiring an external monitor.

5. A device for producing, transmitting, and receiving three-dimension video images of a scene, by using conventional video transmission channels, and a stereoscopic camera, a signal decoder-receiver, and a stereoscopic viewer; characterized in that the stereoscopic camera comprises two parallel lenses that simultaneously receive, encode, modulate, and amplify the video signal; the dual decoder-receiver (left and right) simultaneously processes the signal; the viewer has two liquid crystal or active pixel displays that independently receive the complete image signals with all their attributes.

6. A device for producing, transmitting, and receiving three-dimension video images of a scene as per claim 5, further characterized in that the lenses of the stereoscopic camera are separated apart from each other by a distance that correspond to the average distance between the pupils of the human eyes.

7. A device for producing, transmitting, and receiving three-dimension video images of a scene as per claim 5, further characterized in that the dual receiver-decoder is able to process two simultaneous signals being received by two independent video channels, transmitting them to the viewer, which in turn independently projects them, not requiring an external monitor to do so.

8. A device for producing, transmitting, and receiving three-dimension video images of a scene as per claim 5, further characterized in that the viewer respectively projects the information carried by an independent channel on a corresponding display, that is, the left channel on the left display, and the right channel on the right display.

9. A device for producing, transmitting, and receiving three-dimension video images of a scene as per claim 5, further characterized in that the viewer projects on the display, in real time, the complete information of the image, with no polarization, no superposition, no delay in frequency.
